(19) United States
(12) Patent Application Publication
(10) Pub. No.: US 2002/0178933 A1
(43) Pub. Date: Dec. 5, 2002

(54) Brick stacking method for elongated solid rectangular cut vegetables and product produced thereby

(76) Inventor: Terry L. Long, Sewicklery, PA (US)

Correspondence Address: William L. Muckelroy, Esq., P.C., Ewing Professional Building, 1901 N. Olden Avenue, Suite 3A, Trenton, NJ, 08618, US

(21) Appl. No.: 09/835,779

(22) Filed: Apr. 16, 2001

(51) Int. Cl. A23B 4/00; A47J 17/00

(52) U.S. Cl. 99/537

(57) ABSTRACT

A method for decreasing space requirements during storage, and preventing breakage during transport, of cut potatoes, is shown. This method comprises the steps of preparing potatoes to be cut for food use, cutting the potatoes into rectilinear solids with approximately rectangular cross-sections, having two sets of parallel side faces, each having a width dimension, arranging the rectilinear solids in plurality of close together side-by-side arrays in which one set of parallel side faces are substantially aligned, then stacking the arrays into orderly layers in which the second side faces of are substantially aligned, to create a close stacking mutual support arrangement, and enclosing the arrangement in a suitable container for shipping and storage. In this manner the close stacking arrangement substantially minimizes the storage space required for a unit weight of cut potatoes, and minimizes the exposed cut surfaces to minimize any deleterious effects of exposure to air during storage. At the same time, the close stacking arrangement also permits each rectilinear solid to provide support to its neighbors and in turn receive support from its neighbors, substantially minimizing the breakage of the cut potatoes caused by shifting movements and localized stresses during transport. The arrangement of cut potatoes in this manner is also shown.

### PRIORITY DATE CLAIMED

None.

### CROSS REFERENCE TO RELATED APPLICATIONS

None.

### STATEMENT REGARDING FEDERALLY SPONSORED RESEARCH OR DEVELOPMENT

None.

### BACKGROUND OF THE INVENTION

1. Field of the Invention

The present novel invention relates to packaging for cut vegetables, especially potatoes, carrots, and celery for decreased space requirements during storage and prevention of breakage during transport and a method for stacking same like bricks.

2. Description of Related Art

For many years, cut potatoes have been used in food preparation. While the primary use is the preparation of “French fries”, by baking in ovens, frying the cut potatoes in a deep hot fat or hot oil fryer, there are other known uses as well. Further, such “French fries” vary in dimension, from thin “shoestring” cut potatoes, where the cross-sectional thickness might be on the order of about one one-eighth to one-quarter inch (½ in.), to the larger cuts, which might be called “Ranch Fries” or “Steak Fries”, or some other name, where at least one dimension is larger, on the order of about one-half to about three-quarters of an inch (¾ in.).

Because of the time involved in preparing such cut potatoes, it is common in commercial practice, and for mass production for retailing of one to twenty-five pound packages in food markets for home use as well, to have the potatoes cut and prepared for frying or other cooking ahead of time or even pre-cooked and flash frozen, so that only the relatively quick frying, baking, or microwave operation is required for cooking or heating and serving. Such prepared cut potatoes may be, depending upon the intended use and the desired shelf life, fresh or frozen, and may be raw, partially cooked or “blanched”, or fully cooked.

In the past, the transport and storage of such cut potatoes has presented certain problems. First of all, when potatoes are cut before use, the cut potatoes are typically gathered up in a helter-skelter mass into some kind of package. This package might be a box or a plastic bag of some kind. As with any such disorganized assembly, the package appears full at first, but the contents settle with time, leaving a good deal of empty space in a box, or a collapsed bag. Storage of such partially filled containers requires additional space because of the interstitial voids left in such packages. Further, this inefficient packaging also results in breakage, both as the contents shift and settle, and as the contents are jostled in transport. It is not uncommon, upon opening a container packed in this manner, to find the container somewhat less than full. Further, as the cut potatoes are removed for usage, it is common and the current state of the art to find a large number of broken pieces left at the bottom of the container.

Over the years, there have been many attempts to improve the efficiency of the packaging of prepared foods, but very little of this effort has been directed to cut potatoes. With the result that there is today a need for packaging that will better protect the cut potatoes during transportation and require less space during storage.

Reissued U.S. Pat. No. 9,942, issued to Howe on Nov. 22, 1881. This reference is entitled Package For Shipping Candy Sticks. The reference shows a package for candy sticks in which the candy sticks are formed into a V-shaped wedge and wrapped tightly. A plurality of such V-shaped wedges of candy sticks can then be economically packaged for shipment in a protective cylindrical drum, with minimum breakage due to independent movement of the wedges against each other or from outside force which but for the hard drum would be applied against the stack of wedges.

U.S. Pat. No. 1,852,228, issued to Clarence Birdseye on Apr. 5, 1932. This reference is entitled Consumer Package, and is assigned of record to Frosted Foods Company, of Dover, Del. This reference shows an open-top carton, which can be packed full of perishable food, a loose transparent sheet with an identifying mark thereon laid over the food, and a sealed transparent wrapper enclosing the entire package. The package is then frozen into a solid block.

U.S. Pat. No. 1,952,698, issued to Willem on Mar. 27, 1934. This reference is entitled Butter, and is assigned of record to Stack-Goble Advertising Agency, of Chicago, Illinois. This reference shows the scoring or marking of butter or other plastic food material to indicate predetermined quantities so that the consumer, upon removing the wrapping, may, by use of an ordinary knife, easily cut a predetermined quantity of the product.

U.S. Pat. No. 2,027,596, issued to Kurz on Jan. 14, 1936. This reference is entitled Food Product And Method Of Making The Same, and is not assigned of record. This reference shows a food product wherein a shell formed from a relatively solid food, having physical properties generally similar to an apple or a potato, is combined with a flavoring by a filling of a plastic food such as sausage, peanut butter, jelly, cheese or the like.

U.S. Pat. No. 2,740,573, issued to Carter on Apr. 3, 1956. This reference is entitled Individual Cream Carton. This patent shows a disposable container of a size for an individual serving of cream or the like. The container shown has rectangular sides with flanged end covers each provided with releasable tab portions.

U.S. Pat. No. 3,047,404, issued to Vaughan on Jul. 31, 1962. This reference is entitled Packaging Red Meats, and is assigned of record to the Goodyear Tire & Rubber Company of Akron, Ohio. This reference discloses a method of prolonging the life of freshly cut red meat in which the freshly cut surface of the meat, enclosed in an oxygen-permeable transparent container is exposed to an atmosphere containing at least 30 percent oxygen for a period not greater than five days, and is then displayed for sale. In one embodiment, a plurality of such containers of meat is placed in a transport container in a manner in which the majority of the surface of each package is exposed to the oxygen-enriched atmosphere within the container.

U.S. Pat. No. 3,275,457, issued to Vischer on Sep. 27, 1966. This reference is entitled Frozen Food Product And Package. This reference shows an improved process for freezing soup or other normally viscous liquid food products to reduce the time required to thaw the product for use by utilizing a specific geometry. This is done by freezing the normally liquid food item into pieces having the shape of thin wafers with a high surface area-to-volume ratio. These wafers may also be provided with surface irregularities and perforations to facilitate heat transfer.

U.S. Pat. No. 5,632,378, issued to Provost on May 27, 1997. This reference is entitled Package For Products Of Elongate Shape, And The Method Of Producing It, and is assigned of record to CMB Flexible, of Barbezieux St. Hilaire France. This reference shows a package formed by a wrapper around a plurality of stacked elongate products, each of which temporarily adheres by one of its ends to an end wall of the wrapper. It is intended for prepackaged products, such as strips of chewing gum, and holds the remaining pieces in place after the package has been opened and one or more of the pieces removed.

### OBJECTS OF THE INVENTION

It is an object of the present invention to provide a method for decreasing the space requirements during storage of cut vegetables such as potatoes, celery, and carrots.

It is a further object of the present invention to provide a method for reducing the exposure of cut surfaces of cut vegetables such as potatoes, celery, and carrots to the deleterious effects of air during storage.

It is a still further object of the present invention to provide a method for preventing breakage during transport of cut vegetables such as potatoes, celery, and carrots.

It is a further object of the present invention to provide an arrangement of cut vegetables such as potatoes, celery, and carrots with decreased space requirements during storage.

It is a still further object of the present invention to provide an arrangement of cut vegetables such as potatoes, celery, and carrots that reduces the exposure of cut surfaces to the deleterious effects of air during storage.

It is a still further object of the present invention to provide an arrangement of cut vegetables such as potatoes, celery, and carrots that minimizes the breakage of the cut vegetables caused by shifting movements and localized stresses during transport.

### SUMMARY OF THE INVENTION

According to one embodiment of the present invention, there is provided a method for decreasing space requirements during storage of cut potatoes. The method includes:

a. preparing cut vegetables such as potatoes, celery, and carrots to be cut for food use,

b. cutting said cut vegetables such as potatoes, celery, and carrots into rectilinear solids of extended length and approximately rectangular cross-section, having two sets of parallel side faces, and wherein a first set of parallel side faces has a width of a first dimension, and a second set of parallel side faces has a width of a second dimension,

c. arranging said rectilinear solids in close together side-by-side arrays in which one set of said parallel side faces of approximately equal dimension are substantially aligned,

d. stacking said rectilinear solids arranged in close together side-by-side arrays into repeated orderly layers in which said second set of parallel side faces of approximately equal dimension are substantially aligned to create a close stacking assembly, and;

e. enclosing said close stacking assembly of rectilinear solids in a suitable storage container.

The novel close stacking assembly created by the method substantially minimizes the storage space required for a unit weight of cut vegetables such as potatoes, celery, and carrots, and minimizes the exposed cut surfaces to minimize any deleterious effects of exposure to air during storage.

Another embodiment of the present invention provides a new and novel method for preventing breakage during transport of cut vegetables such as potatoes, celery, and carrots. This novel method includes the steps of:

a. preparing vegetables such as potatoes, celery, and carrots to be cut for food use,

b. cutting said potatoes, celery, or carrots into rectilinear solids of extended length and approximately rectangular cross-section, having two sets of parallel side faces, and wherein a first set of parallel side faces has a width of a first dimension, and a second set of parallel side faces has a width of a second dimension,

c. arranging said rectilinear solids in close together side-by-side arrays in which one set of said parallel side faces of approximately equal dimension are substantially aligned,

d. stacking said rectilinear solids arranged in close together side-by-side arrays into repeated orderly layers in which said second set of parallel side faces of approximately equal dimension are substantially aligned to create a close stacking mutual support assembly, and,

e. enclosing said close stacking mutual support assembly of rectilinear solids in a suitable shipping container.

The close stacking assembly created by the novel method enables each rectilinear solid to support to each contiguous rectilinear solid and in turn receive support from each contiguous rectilinear solid. Thus, the structure created by the novel method minimizing the breakage of said potatoes, celery, or carrots caused by localized stresses and interactions with adjacent cut vegetables during transport.

According to still another embodiment of the present invention, there is provided a method for decreasing space requirements during storage, and preventing breakage during transport, of cut potatoes, celery, and carrots, which method comprises:

a. preparing vegetables such as potatoes, celery, and carrots to be cut for food use,

b. cutting said potatoes into rectilinear solids of extended length and approximately rectangular cross-section, having two sets of parallel side faces, and wherein a first set of parallel side faces has a width of a first dimension, and a second set of parallel side faces has a width of a second dimension,

c. arranging said rectilinear solids in close together side-by-side arrays in which one set of said parallel side faces of approximately equal dimension are substantially aligned,

d. stacking said rectilinear solids arranged in close together side-by-side arrays into repeated orderly layers in which said second set of parallel side faces of approximately equal dimension are substantially aligned to create a close stacking mutual support assembly,

e. enclosing said close stacking mutual support assembly of rectilinear solids in a suitable container for shipping and storage,

wherein said close stacking assembly substantially minimizes the storage space required for a unit weight of cut potatoes, and minimizes the exposed cut surfaces to minimize any deleterious effects of exposure to air during storage, and,

wherein said close stacking assembly permits each rectilinear solid to provide support to each contiguous rectilinear solid and in turn receive support from each contiguous rectilinear solid, substantially minimizing the breakage of said cut potatoes caused by shifting movements and localized stresses during transport.

According to still another embodiment of the present invention, there is provided an arrangement of cut potatoes, celery, or carrots for food use wherein said cut potatoes, celery, or carrots are rectilinear solids of extended length and have approximately rectangular cross-section with two sets of parallel side faces, and wherein a first set of parallel side faces has a width of a first dimension, and a second set of parallel side faces has a width of a second dimension, said arrangement comprising, a close stacking mutual support assembly in which said rectilinear solids are in a plurality of close together side-by-side arrays in which one set of said parallel side faces of approximately equal dimension are substantially aligned, and said close together side-by-side arrays are arranged into repeated orderly layers in which said second set of parallel side faces of approximately equal dimension are substantially aligned.

### BRIEF DESCRIPTION OF THE DRAWINGS

The foregoing and other features and advantages of the present invention are evident upon application of the doctrine of equivalents will be appreciated as the novel invention is better understood from the detailed description of its novel aspects, as further disclosed herein, when taken in conjunction with the following drawings, wherein:

FIG. 1 shows an isometric view, partially exploded to show detail, of a package of cut vegetables packed transverse to the length of the package according to the present invention.

FIG. 2 shows an isometric view of an individual cut vegetable, e.g. a rectangular solid part of a potato, typical of the present invention.

FIG. 3 shows a carton prepared for and receiving a quantity of cut vegetables as provided by the present invention.

FIG. 4 shows an isometric view, partially exploded to show detail, of a package of cut vegetables packed parallel to the length of the package according to the present invention.

### DETAILED DESCRIPTION OF THE INVENTION

FIG. 1 shows an isometric view, partially exploded to show detail, of a package 10 of cut vegetables 12 according to the present invention. The package 10 has a characteristic length, width, and height wherein the width is shorter than the length and the length is shorter than the height. In this view, there is shown an arrangement 14 of cut vegetables 12 for food use wherein the cut vegetables 12 are rectilinear solids 16 of extended length 18.

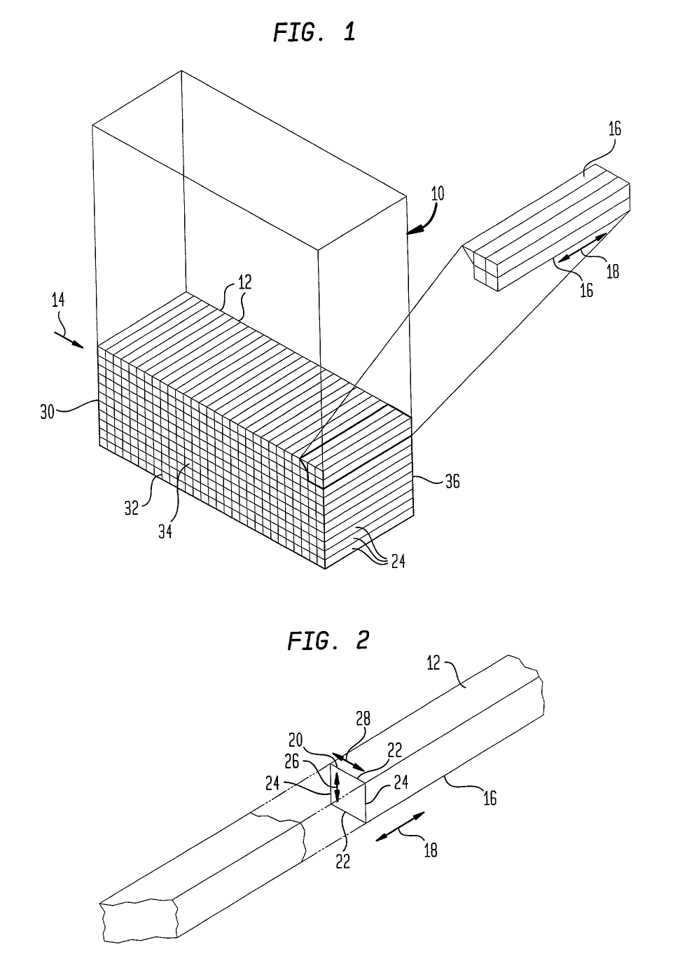

As seen in greater detail in FIG. 2, the rectilinear solid 16 has a rectangular cross-section 20 with two sets of parallel side faces 22 and 24. In this manner, a first set of parallel side faces 22 defines a width or a first dimension 26, and a second set of parallel side faces 24 defines a width or a second dimension 28. The first dimension 26 is approximately the same for each member of the assembly 30. The second dimension 28 is approximately the same for each member of the assembly 30.

With reference to FIG. 1, this arrangement 14 comprises a closely stacked mutual support assembly 30. In the assembly 30, the rectilinear solids 16 are sidewise juxtaposed in a close together side-by-side array 32. In the side-by-side array 32 one set of these parallel side faces 22 has associated therewith a first dimension 26. The first dimension 26 of each of the rectilinear solids is approximately the same. Each first dimension 26 of each of the rectilinear solids are each mutually substantially aligned or substantially parallel in the assembly 30. Further, each of these close together side-by-side arrays 32 is arranged into a fixed number N, e.g. N=25, of repeated orderly layers 34. In these close together side-by-side arrays 32, each of the second set of parallel side faces 24 are approximately aligned.

This arrangement 14 is accomplished by a mechanized or manual method that comprises a series of steps. The first of these steps requires preparing vegetables such as potatoes, carrots, and celery to be cut for food use via automated washing, cleaning, and in selected instances, peeling or removing a first thin outer layer of the vegetable.

Specifically, the term “potatoes”, as used herein, can mean any variety of white, red, or sweet potatoes or yams, and these may be prepared by washing and, if desired, peeling the whole potatoes. With this accomplished using standard mechanized commercial machinery, the whole potatoes is further processed by additional standard commercial cutting and slicing machinery to cut each potato into the rectilinear solids 16 in accordance with the novel invention. These rectilinear solids undergo processing such that they are of approximately the same extended length 18 and approximately rectangular and exhibit the aforedescribed cross-section 20. The rectilinear solids 16 each have two sets of approximately parallel side faces 22 and 24. Each first set of approximately parallel side faces 22 have a width of a first dimension 26, and each second set of parallel side faces 24 have a width of the second dimension 28.

It should also be noted that the present novel invention can be practiced with fresh or frozen cut vegetables, e.g. carrots, celery, and potatoes, and can be practiced with raw, partially cooked or “blanched”, or fully cooked vegetables and other rectangular cut vegetables which have a modulus of rigidity A, bulk modulus k, and elastic limit similar to that of either carrots, potatoes, or celery.

The rectangular solids 16 prepared in this manner are then further processed by the step of arranging same into the close together side-by-side array 32 in which one set of said parallel side faces 22 are further processed by the step of aligning same in a approximate alignment pattern as illustrated in FIGS. 1, 2, 3, and 4.

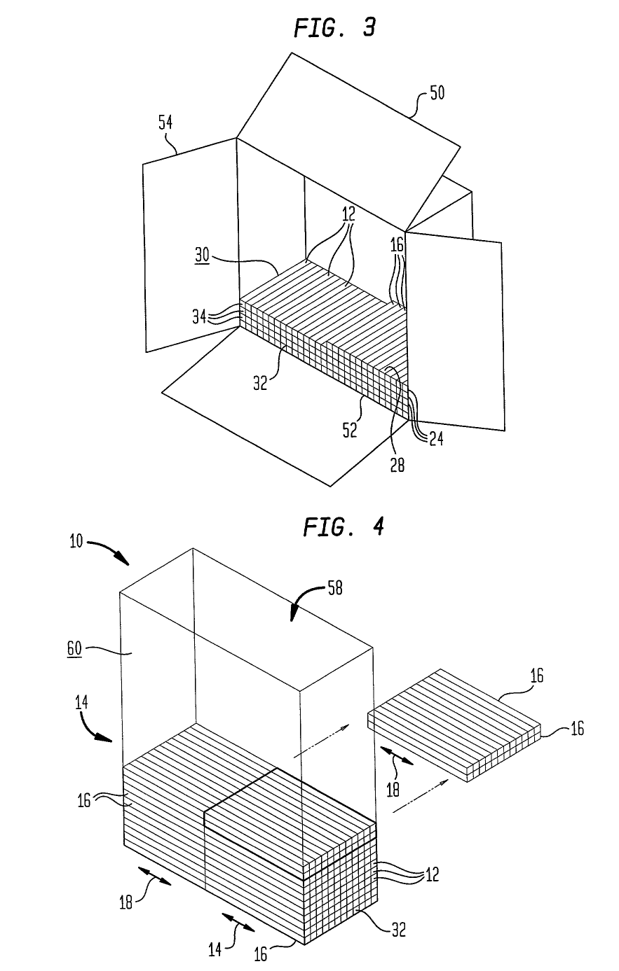

As further shown in FIG. 3, the rectangular solids 16 arranged in close together side-by-side arrays 32 are shown placed in a shipping carton 50, e.g. made of paper board, after being subjected to the step of stacking into repeated orderly layers 34 in which the second set of parallel side faces 24 of a second width dimension 28, are substantially aligned to create a close stacking mutual support assembly 30. The shipping carton 50 has a first set of vertical flaps 52 and second set of vertical flaps 54.

One skilled in the art will recognize that the present novel invention may be practiced with less difficulty if the dimensions of both sets of parallel side faces are equal in dimension.

This close stacking mutual support assembly 30 can then be enclosed in a container suitable for shipping or storage. The container chosen may be a carton of suitable dimension, a plastic bag, or a carton lined with a plastic liner or a plastic bag. The shipping container is normally sealed in some manner, and may contain air or the air may be purged and an inert gas introduced to prolong freshness.

In this manner, the present novel invention provides a close stacking mutual support assembly 30 that substantially minimizes the storage space required for a unit weight of cut vegetables 12, and minimizes the exposed cut surfaces to minimize any deleterious effects of exposure to air during storage. At the same time, the close stacking mutual support assembly 30 permits each rectilinear solid 16 to provide support to each contiguous rectilinear solid 16 and in turn receive support from each contiguous rectilinear solid 16, substantially minimizing the breakage of said cut potatoes caused by shifting movements and localized stresses during transport.

FIG. 3 shows a carton 50 prepared for and receiving a quantity of cut vegetables such as potatoes 12, for example, as provided by the present invention. The carton 50 illustrated is a shallow rectangle having a carton height approximately equal to the greatest dimension of the vegetables it is to contain, or some convenient multiple thereof. In practice, it is useful that the package 10, shown in FIGS. 1 and 4, be a plastic bag or liner and placed inside the carton 50 to help preserve freshness of the cut vegetables 12.

For ease in filling, the carton 50 can be raised onto a side edge and canted both backward and to the side, as illustrated in FIG. 3, to assist in manually stacking an orderly arrangement. Into this carton 50, a quantity of cut vegetables 12 can be placed in the following manner. First, the cut vegetables 12 in the form of rectilinear solids 16 are arranged in a close together side-by-side array 32 along an inside wall of the carton 50, with a first set of parallel side faces 22 (shown in FIG. 2), in parallel arrangement; forming the close together side-by-side array 32. Then, repeated orderly layers 34 of additional close together side-by-side arrays 32 are laid down in the same manner and stacked upon the prior layer, with the second set of parallel side faces 24 in parallel arrangement in each layer 34, until the volume of the carton 50 is approximately filled with cut vegetables 12.

The top opening 58 of the plastic liner 60, shown in FIG. 4 as comprising a containing member of the package 10, is sealed in a conventional manner, e.g. heat-sealing, wire ties, etc. The packaging method further includes the step of purging any air from the package 10 and filling any interstitial space within said package 10 with an inert gas. The package 10 and/or the carton 50 is then further processed by conventional closing and/or taping for shipment and/or storage.

### EXAMPLE

A volume of fresh, whole white potatoes was prepared for food use by thoroughly washing and peeling each potato. These potatoes were then cut into rectilinear solids of the kind commonly referred to as “steak fries” along the longest dimension of each potato, such that each rectilinear solid had a rectangular cross-section having parallel side faces, with a first width dimension of approximately three-eights of an inch ⅜ in. , and a second width dimension of approximately three-quarters of an inch ¾ in.

Two identical cardboard cartons having an interior volume of approximately one cubic foot, and having a height dimension approximately equal to the longest dimension of the potatoes, were each lined with a sealable plastic liner. Into each carton a quantity of the prepared cut potatoes was placed in the following manner:

Into the first carton, a quantity of cut potatoes was dumped from a cutting surface without regard for order. With the exception of attempts to spread the cut potatoes out to uniformly fill in the carton, there was no attempt to bring order to the mass of cut potatoes. When the volume of the carton was filled with cut potatoes in this manner, the plastic liner was sealed and the carton was closed and taped.

The second carton was set into a position as shown in FIG. 3, with one side corner pointing downward and the bottom of the open carton substantially upright but canted slightly back away from vertical, leaving the open top of the carton facing forward and slightly upward. Into this carton a quantity of cut potatoes was placed in the following manner: First, cut potatoes in the form of rectilinear solids were arranged in a close together side-by-side array along the downward-facing side wall of the carton, with the larger side face dimension, three-quarters of an inch ¾ in. in parallel arrangement; forming a close together side-by-side array. Then, repeated layers of additional close together side-by-side layers were laid down in the same manner and stacked upon the first, with the smaller side face dimension, three-eights of an inch ⅜ in. in parallel arrangement in each layer, until the volume of the carton was filled with cut potatoes.

The plastic liner was then sealed in the same manner as in the first carton and the carton was closed and taped.

The two cartons were than weighed, and the second carton was almost twice the weight of the first carton, indicating a much greater amount of cut potatoes was contained within the same unit volume.

The two cartons were not marked in any way that might distinguish them, and were transported together to a second site, where they were opened for inspection.

In the first carton, the volume of potatoes had settled, making the carton appear about three-quarters full when opened. Further, as the potatoes were removed it became apparent that a large number of broken pieces of various sizes were left in the carton.

In the second carton, the contents appeared almost identical to what they had been when the box was sealed, and the number of broken pieces left in the carton as the cut potatoes were removed was remarkable lower.

Further, upon inspection of the cut potatoes from each carton, it appeared that the cut potatoes from the first carton had aged more than the cut potatoes in the second carton, and this difference in appearance was believed to be an effect of the greater quantity of interstitial air contained in the first carton.

It is within the scope of this invention that one skilled in the art may adapt the method, or modify the arrangement of the novel invention disclosed herein for a particular purpose.

Thus, it can be seen from the foregoing description of the currently preferred embodiments and the following claims, that a new and useful method and an arrangement for the shipment and storage of cut potatoes have been illustrated and described and that modifications, equivalents and changes can be made therein by persons of ordinary skill without departing from either the scope of the claims or the spirit of the novel invention.

PARTS LIST

| | |
|---|---|
| 10 | package |
| 12 | cut vegetables |
| 14 | arrangement |
| 16 | rectilinear solids |
| 18 | extended length |
| 20 | rectangular cross-section |
| 22 | first set of parallel side faces |
| 24 | second set of parallel side faces |
| 26 | first dimension |
| 28 | second dimension |
| 30 | close stacking mutual support assembly |
| 32 | side-by-side array |
| 34 | repeated orderly layers |
| 50 | carton |
| 52 | first vertical flap set |
| 54 | second vertical flap set |
| 58 | top opening |
| 60 | plastic liner |

What is claimed is:

1. A method for decreasing space requirements during storage of cut potatoes, which method comprises:
a. preparing potatoes to be cut for food use,
b. cutting said potatoes into rectilinear solids of extended length and approximately rectangular cross-section, having two sets of parallel side faces, and wherein a first set of parallel side faces has a width of a first dimension, and a second set of parallel side faces has a width of a second dimension,
c. arranging said rectilinear solids in close together side-by-side arrays in which one set of said parallel side faces of approximately equal dimension are substantially aligned,
d. stacking said rectilinear solids arranged in close together side-by-side arrays into repeated orderly layers in which said second set of parallel side faces of approximately equal dimension are substantially aligned to create a close stacking assembly,
e. enclosing said close stacking assembly of rectilinear solids in a suitable storage container,
wherein said close stacking assembly substantially minimizes the storage space required for a unit weight of cut potatoes, and minimizes the exposed cut surfaces to minimize any deleterious effects of exposure to air during storage.

2. The method of claim 1 further comprising the step of freezing the contents of the container.

3. The method of claim 1 further comprising the step of purging any air from the container and filling any interstitial space within said container with an inert gas.

4. A method for preventing breakage during transport of cut potatoes, which method comprises:
a. preparing potatoes to be cut for food use,
b. cutting said potatoes into rectilinear solids of extended length and approximately rectangular cross-section, having two sets of parallel side faces, and wherein a first set of parallel side faces has a width of a first dimension, and a second set of parallel side faces has a width of a second dimension,
c. arranging said rectilinear solids in close together side-by-side arrays in which one set of said parallel side faces of approximately equal dimension are substantially aligned,
d. stacking said rectilinear solids arranged in close together side-by-side arrays into repeated orderly layers in which said second set of parallel side faces of approximately equal dimension are substantially aligned to create a close stacking mutual support assembly,
e. enclosing said close stacking mutual support assembly of rectilinear solids in a suitable shipping container,
wherein said close stacking assembly permits each rectilinear solid to provide support to each contiguous rectilinear solid and in turn receive support from each contiguous rectilinear solid, substantially minimizing the breakage of said cut potatoes caused by localized stresses during transport.

5. The method of claim 4 further comprising the step of freezing the contents of the container.

6. The method of claim 4 further comprising the step of purging any air from the container and filling any interstitial space within said container with an inert gas.

7. A method for decreasing space requirements during storage, and preventing breakage during transport, of cut potatoes, which method comprises:
a. preparing potatoes to be cut for food use,
b. cutting said potatoes into rectilinear solids of extended length and approximately rectangular cross-section, having two sets of parallel side faces, and wherein a first set of parallel side faces has a width of a first dimension, and a second set of parallel side faces has a width of a second dimension,
c. arranging said rectilinear solids in close together side-by-side arrays in which one set of said parallel side faces of approximately equal dimension are substantially aligned,
d. stacking said rectilinear solids arranged in close together side-by-side arrays into repeated orderly layers in which said second set of parallel side faces of approximately equal dimension are substantially aligned to create a close stacking mutual support assembly,
e. enclosing said close stacking mutual support assembly of rectilinear solids in a suitable container for shipping and storage,
wherein said close stacking assembly substantially minimizes the storage space required for a unit weight of cut potatoes, and minimizes the exposed cut surfaces to minimize any deleterious effects of exposure to air during storage, and,
wherein said close stacking assembly permits each rectilinear solid to provide support to each contiguous rectilinear solid and in turn receive support from each contiguous rectilinear solid, substantially minimizing the breakage of said cut potatoes caused by shifting movements and localized stresses during transport.

8. The method of claim 7 further comprising the step of freezing the contents of the container.

9. The method of claim 7 further comprising the step of purging any air from the container and filling any interstitial space within said container with an inert gas.

10. An arrangement of cut potatoes for food use wherein said cut potatoes are rectilinear solids of extended length and have approximately rectangular cross-section with two sets of parallel side faces, and wherein a first set of parallel side faces has a width of a first dimension, and a second set of parallel side faces has a width of a second dimension, said arrangement comprising a close stacking mutual support assembly in which said rectilinear solids are in a plurality of close together side-by-side arrays in which one set of said parallel side faces of approximately equal dimension are substantially aligned, and said close together side-by-side arrays are arranged into repeated orderly layers in which said second set of parallel side faces of approximately equal dimension are substantially aligned.

11. The arrangement of cut potatoes of claim 10 in which said width of a first dimension and said width of a second dimension are substantially equal.

12. The arrangement of cut potatoes of claim 10 in which the potatoes are selected from the group consisting of: white potatoes, redskin potatoes, sweet potatoes and yams.

13. The arrangement of cut potatoes of claim 10 in which the potatoes are fresh.

14. The arrangement of cut potatoes of claim 10 in which the potatoes are frozen.

15. The arrangement of cut potatoes of claim 10 in which the potatoes are raw.

16. The arrangement of cut potatoes of claim 10 in which the potatoes are partially cooked.

17. The arrangement of cut potatoes of claim 10 in which the potatoes are cooked.

18. The arrangement of cut potatoes of claim 10 in which the arrangement is packaged in a suitable container for shipping and storage.

19. The arrangement of cut potatoes of claim 18 in which the package is a plastic bag.

20. The arrangement of cut potatoes of claim 18 in which the package is a carton.

21. The arrangement of cut potatoes of claim 20 in which said carton is lined with plastic.
